(19) United States
(12) Patent Application Publication
(10) Pub. No.: US 2026/0339642 A1
(43) Pub. Date: Oct. 29, 2026

(54) SYSTEM AND METHOD FOR AUTOMATED REBUILDING OF ENTERPRISE SERVER INFRASTRUCTURE

(71) Applicant: BANK OF AMERICA CORPORATION, Charlotte, NC (US)

(72) Inventor: Gowrishankar Mookaiah, Robbinsville, NJ (US)

(73) Assignee: BANK OF AMERICA CORPORATION, Charlotte, NC (US)

(21) Appl. No.: 19/189,733

(22) Filed: Apr. 25, 2025

(51) Int. Cl. G06F 8/61; G06F 11/3604

(52) U.S. Cl. CPC G06F 8/63; G06F 11/3604

(57) ABSTRACT

Embodiments of the invention relate to systems, methods, and computer program products for automatically rebuilding an enterprise appliance associated with an entity, the invention including: receiving a user command to initiate a rebuild process, verifying that a configuration file contains a working directory associated with the enterprise appliance, validating one or more image files identified in the working directory, and verifying that the rebuild process is complete based on determining that the enterprise appliance meets one or more predetermined criteria. Embodiments of the invention further include using a remote management interface to install the one or more image files at the enterprise appliance and configure the enterprise appliance based on one or more system requirements associated with the entity.

### FIELD OF THE INVENTION

The present invention embraces a system for automated rebuilding of enterprise server infrastructure.

### BACKGROUND

In the event of an enterprise infrastructure failure (e.g., an appliance reset or complete system wipe), there is a need for a method for automatically rebuilding machines in order to minimize system downtime caused by the infrastructure failure.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the invention relate to systems, methods, and computer program products for automatically rebuilding an enterprise appliance associated with an entity, the invention including: receiving a user command to initiate a rebuild process; verifying that a configuration file contains a working directory associated with the enterprise appliance; validating one or more image files identified in the working directory; using a remote management interface, installing the one or more image files at the enterprise appliance; using the remote management interface, configuring the enterprise appliance based on one or more system requirements associated with the entity; and verifying that the rebuild process is complete based on determining that the enterprise appliance meets one or more predetermined criteria.

In some embodiments, the invention further includes generating the working directory associated with the enterprise appliance, where the working directory includes a list of nodes associated with the enterprise appliance, where each node of the list of nodes is associated with a corresponding image file.

In some embodiments, the invention further includes updating the configuration file based on the generated working directory.

In some embodiments, the invention further includes, prior to installing the one or more image files at the enterprise appliance, resetting the remote management interface.

In some embodiments, installing the one or more image files at the enterprise appliance includes using the remote management interface to update a template file based on the one or more image files.

In some embodiments, verifying that the configuration file contains the working directory associated with the enterprise appliance includes accessing the configuration file from a remote storage location.

In some embodiments, the invention further includes verifying that the rebuild process is complete less than eight hours after receiving the user command to initiate the rebuild process.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1A-1C illustrate technical components of an exemplary distributed computing environment for an automated rebuilding system, in accordance with an embodiment of the disclosure;

FIG. 2 is a block diagram illustrating the automated rebuilding system, in accordance with an embodiment of the disclosure;

FIG. 3A illustrates a process flow for a method of using the automated rebuilding system, in accordance with an embodiment of the disclosure; and

FIG. 3B illustrates a process flow for a method of using the automated rebuilding system, in accordance with an embodiment of the disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

As used herein, an “entity” may be any institution employing information technology resources and particularly technology infrastructure configured for managing electronic workflows. Typically, these workflows can be related to the people who work for the organization, its products or services, the customers or any other aspect of the operations of the organization. As such, the entity may be any institution, group, association, financial institution, establishment, company, union, authority or the like, employing information technology resources for managing electronic workflows.

As described herein, a “user” may be an individual associated with an entity. As such, in some embodiments, the user may be an individual having past relationships, current relationships or potential future relationships with an entity. In some embodiments, a “user” may be an employee (e.g., an associate, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer or a prospective customer. In other embodiments, a user may be a system performing one or more tasks described herein.

As used herein, a “user interface” may be any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of a computer program, or part of a computer program that serves as a foundation for a larger piece of software and drives the functionality of the software. An engine may be self-contained, but externally-controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some embodiments, an engine may be configured to retrieve resources created in other computer programs, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, and/or one or more devices, nodes, clusters, or systems within the system environment described herein. For example, an interaction may refer to a transfer of data between devices, an accessing of stored data by one or more nodes of a computing cluster, a transmission of a requested task, or the like.

As used herein, “production environment” includes various components used to deploy, implement, access, and use, a given application as that application is intended to be used. In various embodiments, production environments include multiple production environment components that are combined; communicatively coupled; virtually and/or physically connected; and/or associated with one another, to provide the production environment implementing the application. In some embodiments, the production environment components making up a given production environment can include, but are not limited to, one or more computing environments used to implement the application in the production environment such as a data center, a cloud computing environment, and/or one or more other computing environments in which one or more components and/or services used by the application in the production environment are implemented; one or more computing systems or computing entities used to implement the application in the production environment; one or more supervisory or control systems, such as hypervisors, used to implement the application in the production environment; one or more communications channels used to implement the application in the production environment; one or more access control systems, such as firewalls and gateways, used to implement the application in the production environment; one or more routing systems, such as routers and switches, used to implement the application in the production environment; one or more communications endpoint proxy systems, such as load balancers or buffers, used to implement the application in the production environment; one or more traffic or access control systems used to implement the application in the production environment; one or more secure communication protocols and/or endpoints, such as Secure Sockets Layer (SSL) protocols, used to implement the application in the production environment; one or more databases used to implement the application in the production environment; one or more internal or external services used to implement the application in the production environment; one or more backend systems, such as backend servers or other hardware used to implement the application in the production environment; one or more software systems used to implement the application in the production environment; and/or any other components making up an actual production environment in which an application is to be deployed, implemented, accessed, and run, as discussed herein, and/or as known in the art at the time of filing, and/or as developed after the time of filing.

As used herein, “machine learning algorithms” may refer to programs (math and logic) that are configured to self-adjust and perform better as they are exposed to more data. To this extent, machine learning algorithms are capable of adjusting their own parameters, given feedback on previous performance in making a prediction about a dataset. Machine learning algorithms contemplated, described, and/or used herein include supervised learning (e.g., using logistic regression, using back propagation neural networks, using random forests, decision trees, and the like), unsupervised learning (e.g., using an Apriori algorithm, using K-means clustering), semi-supervised learning, reinforcement learning (e.g., using a Q-learning algorithm, using temporal difference learning), and/or any other suitable machine learning model types. Each of these types of machine learning algorithms can implement any of one or more of a regression algorithm (e.g., ordinary least squares, logistic regression, stepwise regression, multivariate adaptive regression splines, locally estimated scatterplot smoothing, and the like), an instance-based method (e.g., k-nearest neighbor, learning vector quantization, self-organizing map, and the like), a regularization method (e.g., ridge regression, least absolute shrinkage and selection operator, elastic net, and the like), a decision tree learning method (e.g., classification and regression tree, C4.5, chi-squared automatic interaction detection, decision stump, random forest, multivariate adaptive regression splines, gradient boosting machines, and the like), a Bayesian method (e.g., naïve Bayes, averaged one-dependence estimators, Bayesian belief network, and the like), a kernel method (e.g., a support vector machine, a radial basis function, a linear analysis, and the like), a clustering method (e.g., k-means clustering, expectation maximization, and the like), an associated rule learning algorithm, an artificial neural network model (e.g., a Perceptron method, a back-propagation method, a Hopfield network method, a self-organizing map method, a learning vector quantization method, and the like), a deep learning algorithm (e.g., a deep belief network method, a convolution network method, a stacked auto-encoder method, and the like), a dimensionality reduction method (e.g., principal component analysis, partial least squares regression, multidimensional scaling, projection pursuit, and the like), an ensemble method (e.g., boosting, bootstrapped aggregation, stacked generalization, gradient boosting machine method, random forest method, and the like), and/or any suitable form of machine learning algorithm.

As used herein, “machine learning model” may refer to a mathematical model generated by machine learning algorithms based on sample data, known as training data, to make predictions or decisions without being explicitly programmed to do so. The machine learning model represents what was learned by the machine learning algorithm and represents the rules, numbers, and any other algorithm-specific data structures required to for classification. “Image file” or “image” as used herein refers to a static package of software comprising one or more layers, where the layers comprise all components required to run an application that corresponds to the container image, including, for example, one or more of executable runtime code, system tools, system libraries and configuration settings. “Image file” may further refer to any type of virtual environment that does not include an entire operating system but rather includes all computing resources required to execute at least one process and/or application when supplemented by computing resources from the operating system of the host computing system. In some embodiments, resources and/or processes within the image may be isolated from resources and/or processes outside of the image. In some embodiments, an image may execute only a single process and/or application, while in other embodiments, an image may execute multiple processes and/or applications.

As used herein, “enterprise infrastructure” may refer to one or more virtual machines in which a code base is executed, as well as various virtual devices such as virtual network switches and virtual data storage devices that the virtual machines access while executing a code base. “Infrastructure deployment” may refer to a process of defining a topology of a multi-cloud virtual computing environment for an application, such that the components of the application are able to operate in a unified manner.

An “appliance rebuild” or “infrastructure rebuild” process, as used herein, refers to a process of restoring one or more servers (including both storage and computing nodes) to original (e.g., factory) settings, reinstalling an enterprise system, and applying one or more most recent image files to the server. In conventional systems, appliance rebuild processes are typically performed manually, which is a highly resource intensive tasks and often results in one or more system configurations being left out of the reinstall phase or reinstalled incorrectly. Furthermore, conventional rebuild processes often require up to forty-eight (48) hours to complete, resulting in system downtime and disruption of system processes. To address these problems, the present invention is directed to a system which automatically executes a rebuild process based on a single user command, thereby streamlining system recovery in the event of a failure, ensuring consistency across multiple environments, and minimizing mistakes or omissions created by manual rebuild processes. Furthermore, the present system has been demonstrated to complete the rebuilt process in under eight (8) hours, resulting in a significant reduction in system downtime compared to conventional systems.

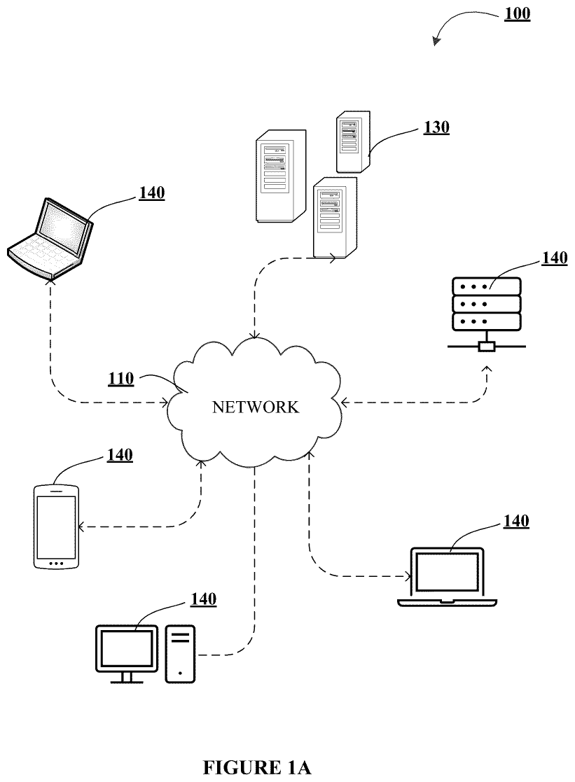

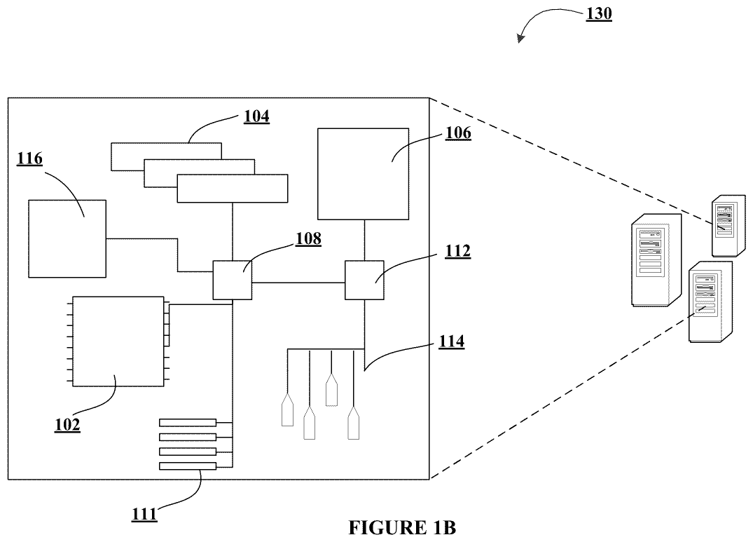

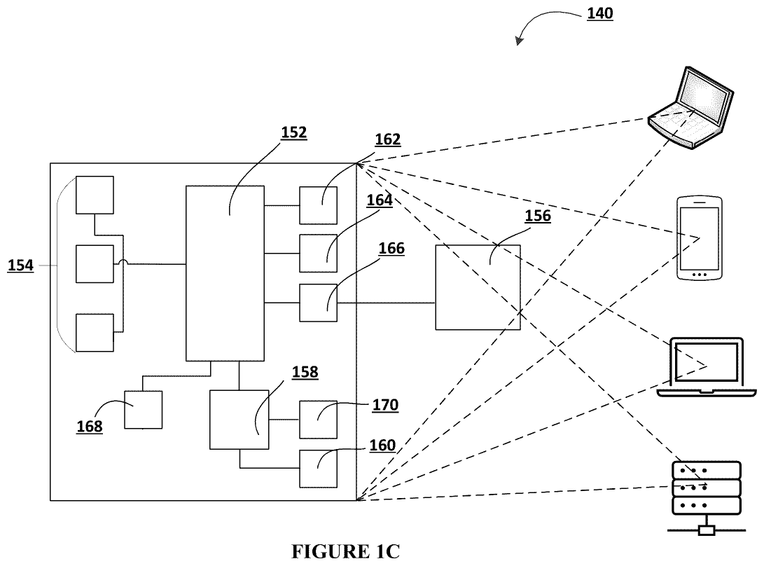

FIGS. 1A-1C illustrate technical components of an exemplary distributed computing environment 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

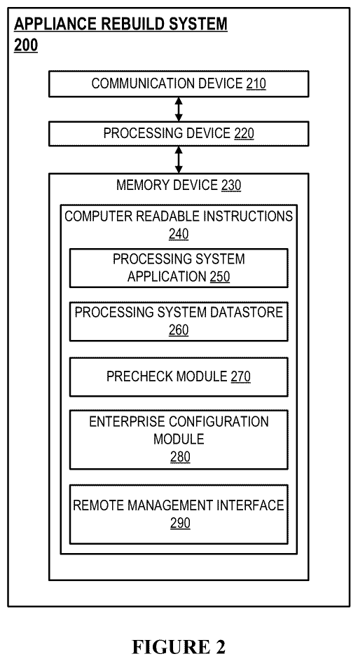

FIG. 2 illustrates a block diagram of an appliance rebuild system 200 associated with the system environment 100, in accordance with embodiments of the present invention. In some embodiments, the system 200 may comprise a software package installed on an end-point device of the system environment 100. As illustrated in FIG. 2, the system 200 may include a communication device 210, a processing device 220, and a memory device 230 having a precheck module 270, an enterprise configuration module 280, a remote management interface 290, a processing system application 250 and a processing system datastore 260 stored therein. As shown, the processing device 220 is operatively connected to and is configured to control and cause the communication device 210 and the memory device 230 to perform one or more functions. In some embodiments, the precheck module 270, enterprise configuration module 280, remote management interface 290, and/or the processing system application 250 comprise computer readable instructions 240 that when executed by the processing device 220 cause the processing device 220 to perform one or more functions and/or transmit control instructions to other systems, applications, and/or devices in the system environment 100. It will be understood that the precheck module 270, enterprise configuration module 280, remote management interface 290, and/or the processing system application 250 may be executable to initiate, perform, complete, and/or facilitate one or more portions of any embodiments described and/or contemplated herein.

The precheck module 270 may be configured to receive one or more structured and/or unstructured data inputs from a user of the end-point device via a user interface, as well as access one or more remote storage locations, such as an enterprise server storing a configuration file. In some embodiments, the precheck module 270 may be configured to establish communication channels with one or more modules or devices for the receipt of structured and/or unstructured data inputs. In some embodiments, the data precheck module 270 may be further configured to perform a series of data processing steps, such as converting data from a first format to a second format, inputting data into a natural language processing engine, and/or the like. In some embodiments, the precheck module 270 may be further configured to read/write data to the configuration file (e.g., by updating a working directory associated with the configuration file). The enterprise configuration module 280 may be configured to store one or more system requirements associated with a particular entity (i.e., control logic associated with data processing rules, system configurations, security requirements, communication protocols, encryption methods, storage and/or backup requirements, and/or the like).

In some embodiments, the precheck module 270 and/or processing system application 250 may be configured to launch and/or access a remote management interface 290. The remote management interface 290 may represent one or more virtual workspaces which may be hosted by a remote server and accessed via a combination of software-based credentials (e.g., authentication credentials, an encrypted token, and/or the like) and/or hardware-based credentials (e.g., a physical token or the like). The remote management interface 290 may be configured to be accessed on an end-point device and may be further configured to execute one or more scripts and/or code bases at a particular enterprise appliance or server. The remote management interface 290 may further store instructions and/or data that may cause or enable the system 200 to receive, store, and/or analyze data received from the precheck module 270, the enterprise configuration module 280, and/or the processing system datastore 260.

The communication device 210 may generally include a modem, server, transceiver, and/or other devices for communicating with other devices on the network 101. The communication device 210 may be a communication interface having one or more communication devices configured to communicate with one or more other devices on the network 101.

Additionally, referring to the system 200 illustrated in FIG. 2, the processing device 220 may generally refer to a device or combination of devices having circuitry used for implementing the communication and/or logic functions of the multilayer decisioning system 200. For example, the processing device 220 may include a control unit, a digital signal processor device, a microprocessor device, and various analog-to-digital converters, digital-to-analog converters, and other support circuits and/or combinations of the foregoing. Control and signal processing functions of the system 200 may be allocated between these processing devices according to their respective capabilities. The processing device 220 may further include functionality to operate one or more software programs based on computer-executable program code 240 thereof, which may be stored in a memory device 230, such as the processing system application 250, the precheck module 270, and/or the remote management interface 290. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 220 may be configured to use the network communication interface of the communication device 210 to transmit and/or receive data and/or commands to and/or from the other devices/systems connected to the network 101.

The memory device 230 within the multilayer decisioning system 200 may generally refer to a device or combination of devices that store one or more forms of computer-readable media for storing data and/or computer-executable program code/instructions. For example, the memory device 230 may include any computer memory that provides an actual or virtual space to temporarily or permanently store data and/or commands provided to the processing device 220 when it carries out its functions described herein. As used herein, memory may include any computer readable medium configured to store data, code, or other information. The memory device 230 may include volatile memory, such as volatile Random Access Memory (RAM) including a cache area for the temporary storage of data. The memory device 420 may also include non-volatile memory, which can be embedded and/or may be removable. The non-volatile memory may additionally or alternatively include an electrically erasable programmable read-only memory (EEPROM), flash memory or the like.

In some instances, various features and functions of the invention are described herein with respect to a “system.” In some instances, the system may refer to the system 200 performing one or more steps described herein in conjunction with other devices and systems, either automatically based on executing computer readable instructions of the memory device 230, or in response to receiving control instructions from another device in the system environment 100. In some instances, the system refers to the devices and systems on the system environment 100 of FIG. 1. The features and functions of various embodiments of the invention are be described below in further detail. It is understood that the servers, systems, and devices described herein illustrate one embodiment of the invention. It is further understood that one or more of the servers, systems, and devices can be combined in other embodiments and still function in the same or similar way as the embodiments described herein.

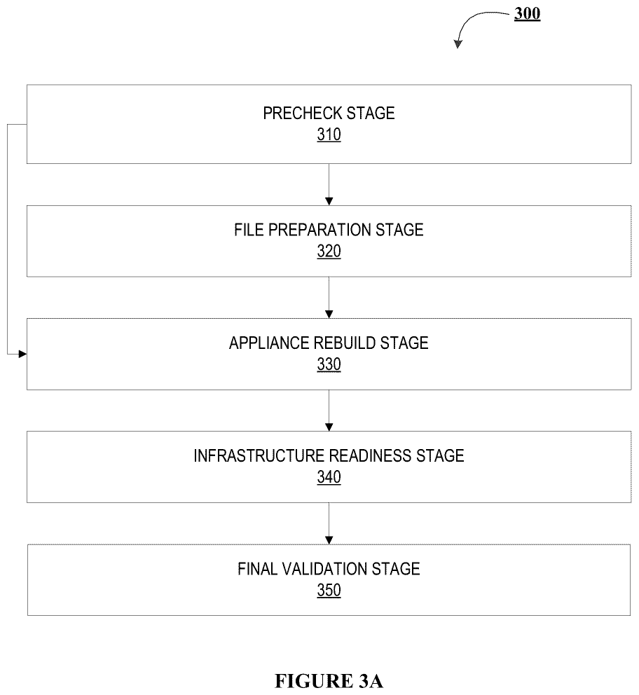

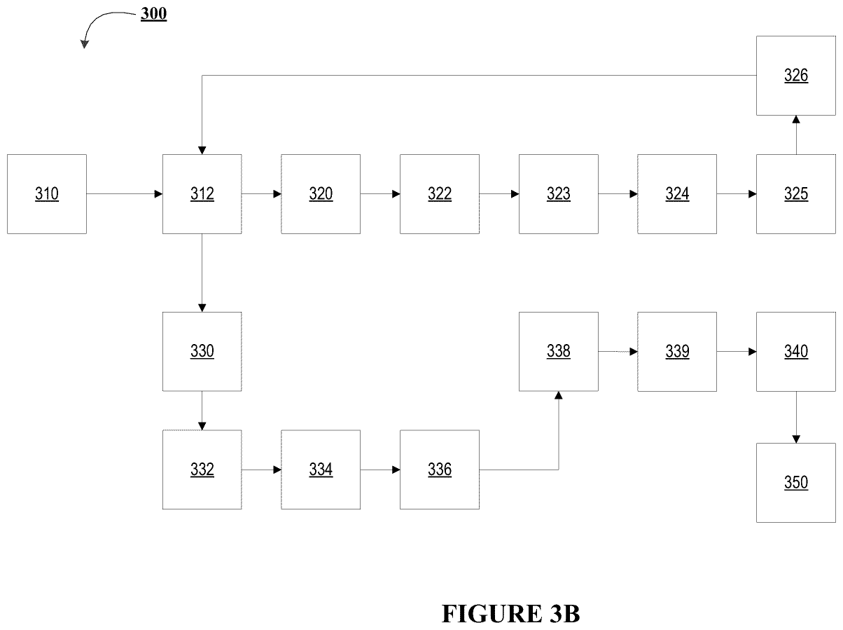

FIGS. 3A-3B are process flow diagrams illustrating a process flow 300 using the system 200, in accordance with some embodiments. Specifically, FIG. 3A illustrates the process flow 300 at a high level, while FIG. 3B illustrates additional sub-processes within the high-level process flow 300. The process flow 300 may begin at a precheck stage 310, where the system is configured to receive a user command to initiate a rebuild process and perform one or more prechecks to verify that the system has access to the data required to execute the rebuild process.

Based on an output and/or result of the precheck stage 310, the process flow may then continue to a file preparation stage 320 or directly to an appliance rebuild stage 330. For example, the system may determine, at the precheck stage 310, that a configuration file associated with the appliance to be rebuilt does not contain a working directory. The system may then proceed to the file preparation stage 320, where the system is configured to generate a working directory associated with the appliance (e.g., by generating and/or accessing a list of nodes associated with the appliance, identifying a corresponding image file associated with each node, updating the configuration file, and/or the like). In another example, the system may determine, at the precheck stage 310, that the configuration file associated with the appliance already contains a working directory. The process flow may then proceed directly to the appliance rebuild stage 330, where the system is configured to use the remote management interface 290 to reboot the appliance and reinstall one or more image files based on information within the configuration file.

The process flow may then proceed to an infrastructure readiness stage 340, where, based on information stored by the enterprise configuration module 280, the system is configured to configure the appliance based on one or more system requirements associated with an entity. Because the system requirements stored by the enterprise configuration module 280 may be updated from time-to-time (for example, one or more security requirements may be updated after an appliance failure), the infrastructure readiness stage 340 ensures that the rebuilt appliance functions in compliance with the most current set of enterprise system requirements.

The process flow may then proceed to a final validation stage 350, where the system may verify that the rebuild process is complete based on determining that the enterprise appliance meets one or more predetermined criteria (e.g., by performing one or system tests configured to test functionalities and performance of the rebuilt appliance). In some embodiments, when the system determines that the rebuild process is complete, the appliance may be brought online (i.e., made available to users and/or end-point devices of an entity system). As described previously, an appliance rebuild process using the process flow 300 may be executed in less than eight hours, reducing the overall system downtime in comparison to conventional appliance rebuild processes.

FIG. 3B illustrates additional sub-processes within the high-level process flow 300. As described, the process flow 300 may begin at the precheck stage 310, where the system receives a user command to initiate a rebuild process and perform one or more prechecks to verify that the system has access to the data required to execute the rebuild process. For example, in some embodiments, the system may, at block 312, check one or more values within a configuration file associated with the appliance to be rebuilt. In some embodiments, block 312 may comprise checking the value of a working directory location variable within the configuration file and determining whether the value is null (i.e., there is no working directory location stored within the configuration file) or not full (i.e., there is a working directory location stored within the configuration file).

If the value of the working directory location is null, the process flow may then proceed to the file preparation stage 320 as described with respect to FIG. 3A. In some embodiments, at block 321, the system may create (e.g., generate) a blank or template working directory associated with the appliance to be rebuilt. Then, at block 322, the system may identify for one or image files associated with the appliance, one or more network file system mounts (i.e., NFS locations) where the image files are stored. In some embodiments, at block 323, the NFS location information of the image files may be saved to a pre-configuration file or the like. Next, at block 324, the system may generate and/or access a list of nodes (e.g., devices, servers, switches, or the like) associated with the appliance to be rebuilt. Then, at block 325, the system may access the image files from the NFS locations and generate the working directory, wherein the working directory comprises the list of nodes, each node being associated with a corresponding image file. At block 326, the system may update the configuration file based on the generated working directory (i.e., updating the value of the working directory location in the configuration file such that the value is not null).

The process flow may then continue to the appliance rebuild stage 330. Additionally or alternatively, if the original value of the working directory location in the configuration file was not null, the process flow may proceed directly to the appliance rebuild stage after block 312. The appliance rebuild stage 330 may begin at block 332, where the system is configured to perform one or more checks to validate that all image files referred to in the working directory exist in the associated NFS locations. After validating that all of the image files exist, the process flow may continue to block 334, where the system may upload the image files at the remote management interface, then use the remote management interface 290 to reset (i.e., reboot) all computing and/or cell servers associated with the appliance. Then, at block 336, the system may validate that all image files are available at the remote management interface 290. At block 338, the system may, using the remote management interface, update a template configuration file based on the image files, then execute the template configuration file such that the image files are installed at the appliance. Finally, at block 339, the system may perform one or more system checks (e.g., tests) to validate that the template configuration file was executed. The process flow may then proceed to the infrastructure readiness stage 340, followed by the final validation stage 350 as described in greater detail with respect to FIG. 3A.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for automatically rebuilding an enterprise appliance associated with an entity, the system comprising:
at least one non-transitory storage device; and
at least one processing device coupled to the at least one non-transitory storage device, wherein the at least one processing device is configured to:
receive a user command to initiate a rebuild process;
verify that a configuration file contains a working directory associated with the enterprise appliance;
validate one or more image files identified in the working directory;
using a remote management interface, install the one or more image files at the enterprise appliance;
using the remote management interface, configure the enterprise appliance based on one or more system requirements associated with the entity; and
verify that the rebuild process is complete based on determining that the enterprise appliance meets one or more predetermined criteria.

2. The system of claim 1, wherein the at least one processing device is further configured to:
generate the working directory associated with the enterprise appliance, wherein the working directory comprises a list of nodes associated with the enterprise appliance, wherein each node of the list of nodes is associated with a corresponding image file.

3. The system of claim 2, wherein the at least one processing device is further configured to update the configuration file based on the generated working directory.

4. The system of claim 1, wherein the at least one processing device is further configured to, prior to installing the one or more image files at the enterprise appliance, reset the remote management interface.

5. The system of claim 1, wherein installing the one or more image files at the enterprise appliance comprises using the remote management interface to update a template file based on the one or more image files.

6. The system of claim 1, wherein verifying that the configuration file contains the working directory associated with the enterprise appliance comprises accessing the configuration file from a remote storage location.

7. The system of claim 1, wherein the at least one processing device is configured to verify that the rebuild process is complete less than eight hours after receiving the user command to initiate the rebuild process.

8. A computer program product for automatically rebuilding an enterprise appliance associated with an entity, the computer program product comprising at least one non-transitory computer-readable medium having computer-readable program code portions embodied therein, the computer-readable program code portions comprising:
an executable portion configured to receive a user command to initiate a rebuild process;
an executable portion configured to verify that a configuration file contains a working directory associated with the enterprise appliance;
an executable portion configured to validate one or more image files identified in the working directory;
an executable portion configured to, using a remote management interface, install the one or more image files at the enterprise appliance;
an executable portion configured to, using the remote management interface, configure the enterprise appliance based on one or more system requirements associated with the entity; and
an executable portion configured to verify that the rebuild process is complete based on determining that the enterprise appliance meets one or more predetermined criteria.

9. The computer program product of claim 8, further comprising an executable portion configured to generate the working directory associated with the enterprise appliance, wherein the working directory comprises a list of nodes associated with the enterprise appliance, wherein each node of the list of nodes is associated with a corresponding image file.

10. The computer program product of claim 9, further comprising an executable portion configured to update the configuration file based on the generated working directory.

11. The computer program product of claim 8, further comprising an executable portion configured to, prior to installing the one or more image files at the enterprise appliance, reset the remote management interface.

12. The computer program product of claim 8, wherein installing the one or more image files at the enterprise appliance comprises using the remote management interface to update a template file based on the one or more image files.

13. The computer program product of claim 8, wherein verifying that the configuration file contains the working directory associated with the enterprise appliance comprises accessing the configuration file from a remote storage location.

14. The computer program product of claim 8, wherein the executable portion configured to verify that the rebuild process is complete is executed less than eight hours after the executable portion configured to receive the user command to initiate the rebuild process is executed.

15. A computer-implemented method for automatically rebuilding an enterprise appliance associated with an entity, the method comprising:
receiving a user command to initiate a rebuild process;
verifying that a configuration file contains a working directory associated with the enterprise appliance;
validating one or more image files identified in the working directory;
using a remote management interface, installing the one or more image files at the enterprise appliance;
using the remote management interface, configuring the enterprise appliance based on one or more system requirements associated with the entity; and
verifying that the rebuild process is complete based on determining that the enterprise appliance meets one or more predetermined criteria.

16. The computer-implemented method of claim 15, further comprising:
generating the working directory associated with the enterprise appliance, wherein the working directory comprises a list of nodes associated with the enterprise appliance, wherein each node of the list of nodes is associated with a corresponding image file; and
updating the configuration file based on the generated working directory.

17. The computer-implemented method of claim 15, further comprising, prior to installing the one or more image files at the enterprise appliance, resetting the remote management interface.

18. The computer-implemented method of claim 15, wherein installing the one or more image files at the enterprise appliance comprises using the remote management interface to update a template file based on the one or more image files.

19. The computer-implemented method of claim 15, wherein verifying that the configuration file contains the working directory associated with the enterprise appliance comprises accessing the configuration file from a remote storage location.

20. The computer-implemented method of claim 15, wherein verifying that the rebuild process is complete occurs less than eight hours after receiving the user command to initiate the rebuild process.
